(19) United States
(12) Patent Application Publication
(10) Pub. No.: US 2024/0097539 A1
(43) Pub. Date: Mar. 21, 2024

(54) METHOD FOR FORMING A STATOR WINDING, SHEET-METAL STATOR, AND ELECTRIC MOTOR

(71) Applicant: Brose Fahrzeugteile SE & Co. Kommanditgesellschaft, Würzburg, Würzburg (DE)

(72) Inventors: Wolfgang Strauss, Unterpleichfeld (DE); Alexander Volkamer, Oberscheinfeld (DE); Jürgen Köstner, Dettelbach (DE); Rudolph Hart, Güntersleben (DE); Daniel Brehl, Künzell-Dirlos (DE); Frank Sebert, Bergtheim (DE); Selin Pfarr, Wipfeld (DE)

(21) Appl. No.: 18/515,586

(22) Filed: Nov. 21, 2023

Related U.S. Application Data
(63) Continuation of application No. PCT/EP2022/063545, filed on May 19, 2022.

(30) Foreign Application Priority Data
May 21, 2021 (DE) 10 2021 205 242.8

(51) Int. Cl. H02K 15/095; H02K 3/20

(52) U.S. Cl. CPC H02K 15/095; H02K 3/20

(57) ABSTRACT

A stator winding of a sheet-metal stator for an electric motor. A stator lamination stack of the stator is equipped with an insulating end plate. Stator teeth protruding in the radial direction are wound with a winding wire. After a specified number of stator teeth, the winding wire is guided away from the stator lamination stack and then back to the stator lamination stack, thereby forming an at least U-shaped loop. The loop is then used to contact a motor electronics unit of the electric motor.

### CROSS-REFERENCE TO RELATED APPLICATION

This application is a continuation, under 35 U.S.C. § 120, of copending International Patent Application PCT/EP2022/063545, filed May 19, 2022, which designated the United States; this application also claims the priority, under 35 U.S.C. § 119, of German Patent Application DE 10 2021 205 242.8, filed May 21, 2021; the prior applications are herewith incorporated by reference in their entirety.

### FIELD AND BACKGROUND OF THE INVENTION

The invention concerns a method for forming a stator winding of a full metal stator for an electric motor. The invention furthermore concerns such a full metal stator and an electric motor.

A laminated core stator (also known as an annular laminated core, or lamination stack stator) is usually a stator which is formed from a laminated core in which the individual laminations are closed as a ring. So-called (stator) teeth, which are spaced apart from one another by a respective groove in the laminated core and in the correct usage state carry a coil wound from a coil wire for generating a magnetic field, protrude radially inward in a full metal stator with inner grooves. In contrast, stators are also known which are formed from so-called teeth chains. The laminated core is here folded up between the individual teeth, wound in the open state, and then joined together into the stator ring.

The coils formed on the individual teeth, depending on the design of the electric motor, are for example connected alternately with two or also three phases of an electrical network. Connection usually takes place (mostly indirectly via motor electronics) via an end face of the stator on which the corresponding motor electronics are also arranged. Various types of insulation are known for preventing an electrical short between the coil wire and the laminated core. Usually however, independently of the insulation along the grooves in the laminated core—at least in a full metal stator—a so-called insulating end disc is arranged on the end faces. This can be pushed on, molded on or over-molded, together with an insulation of the grooves and teeth, as a body around the stator lamination stack. On the connection side, i.e., on the side at which the coils are contacted and the motor electronics arranged, the insulating end disc has so-called terminating domes, i.e., axially projecting protrusions on which the coil wire can be fixed for the so-called termination. “Termination” means the routing of the coil wire to the contact point and/or between at least two coils assigned to the same phase. Usually, contacting devices, e.g. receivers for so-called insulation displacement contacts in which the coil wire for contacting the motor electronics is attached, are also arranged on the insulating end disc. The smaller the electric motor and hence also the stator, the less installation space however remains on the insulating end disc for the terminating domes and/or the contacting devices, so that these must be made smaller and hence have lower mechanical strength.

### SUMMARY OF THE INVENTION

The invention is based on the object of providing an improved method of forming a stator winding, an improved stator, and an improved electric motor.

With the above and other objects in view there is provided, in accordance with the invention, a method of forming a stator winding of a stator for an electric motor, the method comprising:
providing a stator lamination stack of the stator with an insulating end disc,
winding stator teeth protruding in a radial direction with a winding wire;
after winding a predefined number of stator teeth, guiding the winding wire away from the stator lamination stack and then back, forming a U-shaped loop; and
using the loop for connecting the winding wire to a motor electronics of the electric motor.

The method according to the invention serves for forming a stator winding of a sheet-metal stator for an electric motor. Here, according to the method, a stator lamination stack of the sheet-metal stator is equipped with an insulating end disc, in particular on the end face. Stator teeth protruding in the radial direction, in particular towards the inside, of the stator lamination stack (in brief: “teeth”) are wound with a winding wire (or “coil wire”), to form an assigned coil. After a predefined number of stator teeth (i.e., after forming a corresponding number of coils), the winding wire is guided away from the stator lamination stack and then back, forming an at least U-shaped loop. This loop is then used for connecting the corresponding number of coils to a motor electronics. In other words, a loose wire loop is routed, wherein the term “loose” herein means in particular that the loop firstly (i.e., in an intermediate production stage) “hangs” freely in space, and does not lie on the insulating end disc, at least over a substantial part (i.e., more than at least 50 percent of the loop length).

Because the loop serving for connection is initially routed freely or loosely, it need not be attached to the insulating end disc (in particular for electrical connection to mechanical means, e.g., insulation displacement contacts), so any element necessary for this may be omitted and hence a compact design of the insulating end disc is possible.

Preferably, the respective loop is routed, preferably at least roughly radially, towards the outside of the stator lamination stack. This simplifies the handling of the loops in the following stages, since the loops are comparatively easily accessible on the outside of the stator lamination stack.

Usually, several so-called terminating domes are formed on the insulating end disc. These are column-like protrusions which preferably protrude in the axial direction. In a suitable method variant, the, or each, loop is arranged next to one of the terminating domes in the circumferential direction of the stator lamination stack. Also, an auxiliary loop for fixing the respective loop is laid around the corresponding terminating dome before and/or after the respective loop in the laying direction of the winding wire. The terminating domes are in any case required for routing (“terminating”) the coil wire along the insulating end disc between the assigned teeth. Preferably, for each loop, only one auxiliary loop is routed in order to save coil wire and keep the electrical resistance over the length of the coil wire to a minimum. It has been found that one auxiliary loop alone is sufficient to fix the loop for adequate ease of handling.

The term “circumferential direction” hereinbelow means the direction that is tangential to the approximately annular stator lamination stack (and to the rotational axis, arranged centrally in the stator, of a rotor arranged rotatably therein in the final production state). The term “radial direction” accordingly means a direction running perpendicularly to the rotational axis. The axial direction thus designates the direction running along the rotational axis.

In a further suitable method variant, the, or each, loop is formed in a gamma shape—or as an “eye” (in the sense commonly used in knotting). The loop is thus routed as a closed ring; the coil wire is wound through at least 360 degrees and crosses itself. Optionally however, also (additionally or alternatively) “open” loops, which do not cross themselves, are laid (i.e., in particular U-shaped or arcuate loops).

Preferably, the above-described auxiliary loop is routed (in particular only) after the corresponding, in particular eye-type loop. It is therefore possible to “hold down” the entire loop, e.g. by crossing the coil wire when laying the loop. When laying the eye, the “end” of the eye crosses its beginning and thus lies above this (viewed in the axial direction). If the auxiliary loop is now laid at this point, this advantageously also holds down the start of the eye.

In a further suitable method variant, the auxiliary loop is laid through at least 360 degrees around the terminating dome. This allows a sufficiently secure fastening of the loop.

In an additional (in particular to the auxiliary loop) or alternative method variant, the winding wire is clamped in a fixing slot of the insulating end disc before and/or after the respective loop.

Preferably, the, or each, loop is fastened to an additional component in a subsequent production stage, in particular for later connection.

In a preferred method variant, a contacting ring is placed as the additional component on the wound insulating end disc (i.e., after winding the coils and laying the loops and, where applicable, auxiliary loops). This contacting ring is in particular a ring made of plastic. This has a number of receiving windows (or contact windows) corresponding to the number of loops. The loops are laid radially towards the inside over the contacting ring, preferably after its positioning. Each loop is laid in a correspondingly assigned receiving window and preferably clamped therein.

In a suitable embodiment, the contact windows are also configured for receiving an insulation displacement contact. The respective loop in this case is suitably contacted by means of such an insulation displacement contact, which is inserted in the contacting ring (preferably in the contact window). Preferably, the insulating displacement contacts serve for electrical connection of the above-mentioned motor electronics.

The stacked sheet-metal stator according to the invention serves for use in an electric motor. The stator, as evident from the above description, comprises the stator lamination stack with the insulating end disc. Also, the stacked sheet-metal stator comprises stator teeth protruding in the radial direction which are wound with a winding wire, forming a respective loop. At least in the intermediate production stage, after a predefined number of stator teeth, the winding wire is guided away from the stator lamination stack and back again, preferably roughly radially towards the outside of the stator lamination stack, forming the above-described at least U-shaped loop. The, or each, loop serves for contacting a motor electronics. In particular, the full metal stator according to the invention is produced by means of the above-described method.

The electric motor according to the invention comprises the above-described sheet-metal stator.

The stacked sheet-metal stator and the electric motor thus also have the further physical features arising from the above description of the method, e.g., the or the respective auxiliary loop and/or the contacting ring. Thus the stator and the electric motor also offer the same advantages.

Other features which are considered as characteristic for the invention are set forth in the appended claims.

Although the invention is illustrated and described herein as embodied in a method for forming a stator winding, stacked sheet-metal stator, and electric motor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic view onto an end face of a sheet metal stator in an intermediate production stage; and

FIG. 2 is a schematic side view of the sheet metal stator in a further production stage.

Mutually corresponding components and values carry the same reference signs throughout the figures.

### DETAILED DESCRIPTION OF THE INVENTION

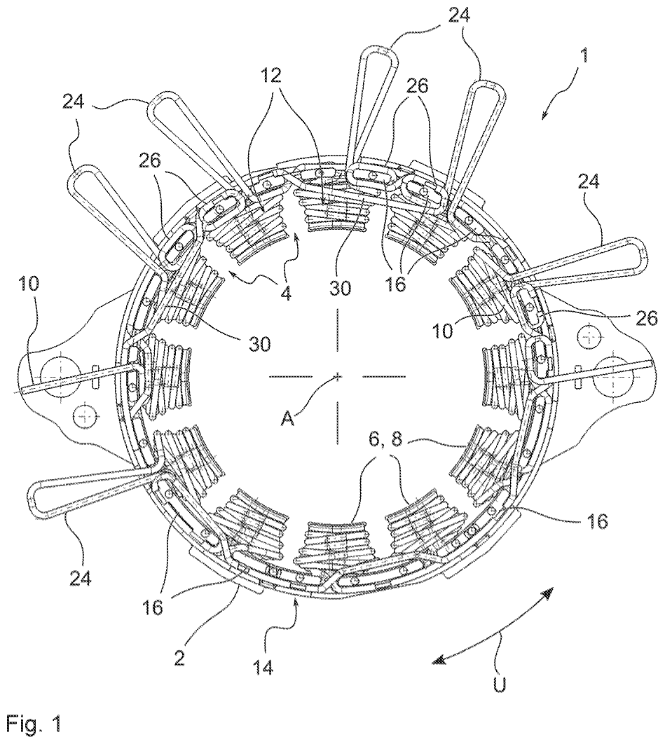

Referring now to the figures of the drawing in detail and first, in particular, to FIG. 1 thereof, there is shown a schematic view onto an end face of a (sheet metal) stator 1 of an electric motor. The stator may also be referred to as a full metal stator. In the normal, correct usage, the stator 1 is inserted, usually pressed, into a housing of the electric motor. The stator 1 is formed by a stator lamination stack 2, also referred to as a laminated core 2, which has stator laminations stacked on top of one another along an axis A. Radially on the inside relative to the axis A, a plurality of grooves 4 are cut into these stator lamination stack and hence also into the laminated core 2. Protrusions of the stator lamination stack 2, which protrude radially inward between the grooves 4 from a ring closed in a circumferential direction U, are hereinbelow referred to as stator teeth, or “teeth 6.” So-called pole shoes 8 (or pole shoe tips) are formed radially on the inside of these teeth 6. They have an edge which points towards the axis A and forms a circle ring portion, and in the correct usage state is arranged with a slight air gap from a rotor, which is received in the stator 1 so to be rotatable about the axis A. FIG. 1 shows an intermediate production stage in the production of the stator 1.

In order to be able to build up a magnetic field that is necessary for the operation of the electric motor, the teeth 6 are wrapped with a winding or coil wire 10 so that each tooth 6 carries an assigned coil 12. This is also known as a concentrated winding. In order to achieve the maximum possible electrical power capacity, the individual turns of the wire must lie as closely together as possible.

In the exemplary embodiment shown, the stator 1 has twelve teeth 6 (and hence also twelve poles). Multiple coils 12 are connected together; in particular, the winding wire 10 is routed between the corresponding teeth 6 along a so-called insulating end disc 14, which in the present exemplary embodiment is placed onto the stator lamination stack 2 as a separate component. The insulating end disc 14 here carries several “terminating domes 16,” i.e., axially extended columns or protrusions around which the winding wire 10 is routed in order to maintain its tension and prevent a loosening of the coils 12.

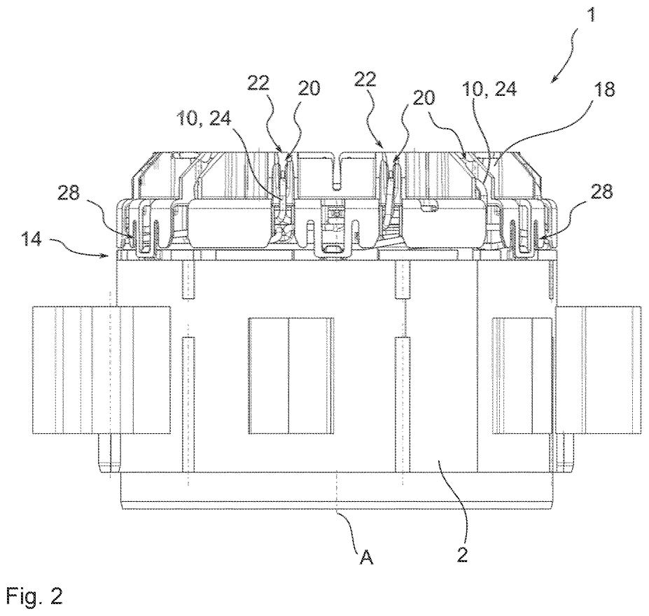

In the present exemplary embodiment, the stator 1 is so small that, in the region of the ring of the stator lamination stack 2, there is insufficient space for contact points into which the winding wire 10 could be laid. For this reason, after forming the coils 12 and hence also after termination of the winding wire 10 along the insulating end disc 14, a further component—here a contacting ring 18 (see FIG. 2)—is placed onto the stator lamination stack 2. This contacting ring 18 comprises contact windows 20 (or receiving windows), in which later the winding wire 10 will be contacted by means of insulation displacement contacts 22.

For this, when routing the winding wire 10, after a predefined number of wound coils 12, a “loose” loop 24 is laid over the insulating end disc 14 towards the outside of the stator lamination stack 2 (see FIG. 2). The respective loop 24 is here routed between two terminating domes 16. After the loop 24 in the routing direction, a “fixed” auxiliary loop 26 (or auxiliary winding) is laid around the terminating dome 16 arranged on the end of the loop 24—i.e., the loop 24 is arranged between the last coil 12 wound with this winding wire 10 and the corresponding auxiliary loop 26. This auxiliary loop 26 allows the loose loop 24 to remain—at least within manageable limits—in its routing position and its orientation.

When all loops 24 and auxiliary loops 26 have been laid, the contacting ring 18 is placed on the insulating end disc 14 and connected thereto, in the present exemplary embodiment for example by means of snap connections 28. The loops 24 are then folded inward by around 180 degrees, i.e., bent over the contacting ring 18. The contact windows 20 are arranged at the sites of the loops 24, so that the inwardly bent loops 24 now lie in the contact windows 20 and are preferably clamped there. Then the insulation displacement contacts 22 are inserted in the contact windows 20, contacting the winding wire 10 of the loops 24.

The motor electronics are then positioned (not shown in detail), which are also galvanically connected to the insulation displacement contacts 22, in particular to further terminal clamps formed on the same metal part which carries the terminal clamps for the winding wire 10 and forms the insulation displacement contact 22.

In principle, the winding wire 10 of the coils 12 is routed outside the terminating domes 16. In order however to keep crossovers of the winding wire 10 of different coils 12 on the insulating end disc 14 to a minimum, in an optional exemplary embodiment shown here, the winding wire 10 is also routed partially radially inside the terminating domes 16. Firstly, for this—and also for its fixing and clamping, alternatively or additionally to the above-described auxiliary loops 26—the winding wire 10 meanders partially around the terminating domes 16. Secondly, radially inside the terminating domes 16, the winding wire 10 is also “tensioned” at some points between (at least) two or even three terminating domes 16. Here, the winding wire 10 forms a respective circle chord 30 which runs between the ends of two terminating domes 16 facing away from one another in the circumferential direction U. The meandering of the winding wire 10 around the terminating domes 16 adjacent to the circle chord 30 is also sufficient to clamp the circle chord 30. This routing of the wire partially radially inside the terminating domes 16 also saves installation space in the region of the insulating end disc 14.

It will be understood that the subject of the invention is not restricted to the above-described exemplary embodiment. Rather, further embodiments of the invention may be derived from the above description by the person skilled in the art.

The following is a summary list of reference numerals and the corresponding structure used in the above description of the invention:
1 Stator
2 Stator lamination stack, laminated core
4 Groove
6 Tooth
8 Pole shoe
10 Winding wire
12 Coil
14 Insulating end disc
16 Terminating dome
18 Contacting ring
20 Contact window
22 Insulation displacement contact
24 Loop
26 Auxiliary loop
28 Snap connection
30 Circle chord
A Axis
U Circumferential direction

1. A method of forming a stator winding of a stator for an electric motor, the method comprising:
providing a stator lamination stack of the stator with an insulating end disc,
winding stator teeth protruding in a radial direction with a winding wire;
after winding a predefined number of stator teeth, guiding the winding wire away from the stator lamination stack and then back, forming a U-shaped loop; and
using the loop for connecting the winding wire to a motor electronics of the electric motor.

2. The method according to claim 1, which comprises laying the loop to be oriented at least approximately radially outward from the stator lamination stack.

3. The method according to claim 1, wherein the insulating end disc is formed with a plurality of terminating domes protruding in an axial direction and the method comprises arranging each loop next to one of the terminating domes in a circumferential direction of the stator lamination stack, and laying an auxiliary loop for fixing the respective loop around the corresponding terminating dome before and/or after forming the respective loop in the laying direction of the winding wire.

4. The method according to claim 3, which comprises laying the auxiliary loop through at least 360 degrees around the terminating dome.

5. The method according to claim 1, which comprises forming the loop or each loop in a gamma shape.

6. The method according to claim 5, which comprises laying the auxiliary loop through at least 360 degrees around the terminating dome.

7. The method according to claim 1, which comprises clamping the winding wire in a fixing slot of the insulating end disc before and/or after forming the respective loop.

8. The method according to claim 1, which comprises placing a contacting ring having a number of receiving windows corresponding to a number of the loops on the wound insulating end disc, and laying the loops radially towards an inside over the contacting ring, and laying each loop in a correspondingly assigned receiving window.

9. The method according to claim 8, which comprises contacting the respective loop by way of an insulation displacement contact which is inserted in the contacting ring.

10. A sheet-metal stator for an electric motor, the stator comprising:
a stator lamination stack with an insulating end disc;
stator teeth protruding in a radial direction; and
winding wire wound around said stator teeth; and
after a predefined number of stator teeth, a course of said winding wire being guided roughly radially towards an outside of said stator lamination stack, forming a substantially U-shaped loop, with the loop being provided for contacting a motor electronics of the electric motor.

11. An electric motor, comprising a sheet metal stator according to claim 10.
